(19) United States
(12) Patent Application Publication
(10) Pub. No.: US 2023/0396190 A1
(43) Pub. Date: Dec. 7, 2023

(54) SYSTEMS AND METHODS OF HARVESTING ENERGY USING SHOE INSERTS

(71) Applicant: Lino E. Marrero, Frisco, TX (US)

(72) Inventor: Lino E. Marrero, Frisco, TX (US)

(21) Appl. No.: 18/169,357

(22) Filed: Feb. 15, 2023

Related U.S. Application Data
(60) Provisional application No. 63/348,068, filed on Jun. 2, 2022.

(51) Int. Cl. H02N 2/18; H02J 7/00; A43B 17/00

(52) U.S. Cl. CPC H02N 2/18; H02J 7/0042; A43B 17/00

(57) ABSTRACT

A method of harvesting energy that includes providing an insert for a shoe, receiving a mechanical signal by one or more of at least two electromechanical transducers disposed along opposite surfaces of the insert, and converting the mechanical signal into an electrical signal. The method further includes converting the electrical signal from an alternating current to a direct current and discharging the direct current into a power bank when a bridge circuit of the insert is electrically coupled to the power bank.

### RELATED APPLICATIONS

This application claims the priority benefit of U.S. Provisional Application No. 63/348,068, filed Jun. 2, 2022 and entitled, “Systems and Methods of Harvesting Energy Using Shoe Inserts,” which is incorporated by reference in its entirety.

### TECHNICAL FIELD

This disclosure relates generally to harvesting energy, and more particularly, to systems and methods of harvesting energy using shoe inserts.

### BACKGROUND

The world is facing an energy crisis. In 100 years or less, Earth will run out of resources, and in 50 years or less, Earth will run out of fossil fuels. Currently, fossil fuels account for over 80% of the energy used in the United States. While energy access has been increasing globally, energy is not allocated equally. Poor energy access is strongly tied to low income, and 13% of the world does not have access to electricity.

Conventional methods of harvesting energy include using wind turbines to harvest wind energy, solar panels to harvest solar energy, extraction procedures such as drilling, fracking, and pumping to harvest oil and gas, and nuclear fission and nuclear fusion to harvest nuclear energy. These methods are typically not readily available to the average person or low-income communities because of the cost, specialized knowledge, skills, tools, and/or equipment required to implement these methods. As a result, many average people and low-income communities have limited or no access to electricity.

### SUMMARY OF THE DISCLOSURE

According to one embodiment, a system for harvesting energy includes a shoe, an insert adapted to fit in the shoe, and a power bank. The insert includes a ball portion, a heel portion, at least one electromechanical transducer, a bridge circuit, a capacitor, a cable, and a switch. The ball portion is positioned proximal to the first end of the insert and the heel portion is positioned distal to the first end of the insert. The at least one electrochemical transducer is configured to convert the mechanical signal into an electrical signal. The at least one electromechanical transducer is disposed along the insert extending from the heel portion and includes a first and second electromechanical transducer. The first electromechanical transducer is a piezoelectric sensor disposed along a first surface of the insert, and the second electromechanical transducer is a piezoelectric sensor disposed along a second surface of the insert, which is opposite the first surface. The bridge circuit is electrically coupled to the at least one electromechanical transducer and is a diode rectifier bridge. The bridge circuit is configured to convert the electrical signal generated by the at least one electromechanical transducer from alternating current to direct current and discharge the direct current. The capacitor is electrically coupled to the bridge circuit and is configured to receive and store the direct current discharged by the bridge circuit. The cable is electrically coupled to the capacitor and configured to direct the flow of direct current discharged from the capacitor. The cable is configured to protrude through the first surface of the insert proximal to the first end of the insert and thread through at least one aperture of the shoe. The switch is electrically coupled to the capacitor and is configured to permit or restrict the flow of the direct current from the capacitor. The power bank is adapted to couple the shoe or a shoelace. The power bank is configured to electrically couple to the insert via the cable, receive the direct current discharged from the insert when the switch permits the flow of the direct current, and store the direct current.

According to another embodiment, an insert for a shoe includes a ball portion, a heel portion, at least two electromechanical transducers, and a bridge circuit. The ball portion is positioned proximal to a first end of the insert and the heel portion is positioned proximal to a second end of the insert, which is opposite the first end. The at least two electromechanical transducers are configured to convert a mechanical signal into an electrical signal. One of the at least two electromechanical transducers is disposed along a first surface of the insert extending from the heel portion. Another of the at least two electromechanical transducers is disposed along a second surface of the insert, the second surface being opposite the first surface. The bridge circuit is electrically coupled to the at least two electromechanical transducers. The bridge circuit is configured to convert the electrical signal generated by one of the at least two electromechanical transducers from alternating current to direct current. The bridge circuit is further configured to discharge the direct current into a power bank when the bridge circuit is electrically coupled to the power bank.

According to yet another embodiment, a method involves providing an insert for a shoe, which includes a ball portion, a heel portion, at least two electromechanical transducers, and a bridge circuit. The ball portion is positioned proximal to a first end of the insert and the heel portion is positioned proximal to a second end of the insert, which is opposite the first end. One of the at least two electromechanical transducers is disposed along a first surface of the insert extending from the heel portion. Another of the at least two electromechanical transducers is disposed along a second surface of the insert, the second surface being opposite the first surface. The method includes receiving, by one or more of the at least two electromechanical transducers, a mechanical signal. The method further includes converting, by the one or more of the at least two electromechanical transducers, the mechanical signal into an electrical signal. The method includes converting, by a bridge circuit, the electrical signal from an alternating current to a direct current. And the method includes discharging, by the bridge circuit, the direct current into a power bank when the bridge circuit is electrically coupled to the power bank.

Certain embodiments of the present disclosure may provide one or more technical advantages. One advantage of the present disclosure allows for the harvesting of electrical energy generated by bodily movement, such as walking, running, jumping, riding a bike, driving a car, or any other type of physical activity where shoes are advised or required. Another advantage of the present disclosure allows for the depositing of harvested energy in a personal and/or shared storage device for later consumption by an individual and/or community (e.g., to power geographical locations with poor energy access).

Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and for further features and advantages thereof, reference is now made to the following description taken in conjunction with the accompanying drawings, in which:

FIG. 1 illustrates a shoe insert for harvesting energy, according to certain embodiments of the present disclosure;

FIG. 2 illustrates a system including a shoe and a shoe insert, according to certain embodiments of the present disclosure; and

FIG. 3 is a flowchart illustrating a method of harvesting energy using a shoe insert (e.g., insert 100 of FIG. 1 and/or insert 202 of FIG. 2), according to certain embodiments of the present disclosure.

### DETAILED DESCRIPTION OF THE INVENTION

Energy generation is a serious concern in the modern world. Traditional methods of energy generation such as wind and solar energy, power plants, and combustion engines can be costly, require specialized expertise to implement and use, and require materials not readily available to certain demographics and areas of the world. As the world faces an energy crisis, even the demographics and areas that enjoy sufficient energy access would benefit from new methods of harvesting energy. Accordingly, there exists a need to find creative, cost-effective, and accessible ways to power the world.

The present disclosure describes and illustrates a system and method for harvesting energy. The systems and methods contemplated herein harvest energy via a shoe insert adapted to convert energy generated from bodily movement (e.g., walking, running, jumping, riding a bike, driving a car, and any other type of physical activity where shoes are advised or required) to a form usable by electronic devices (e.g., cellphones, computers, lights, furnaces, appliances, and vehicles). In some embodiments, the insert is an insole. In other embodiments, the insert may be adapted to be fitted and sealed within a sole of a shoe (e.g., shoe 214). By using the insert described herein, individual(s) may be able to generate and harvest the energy exerted by moving about, resulting in a cost-effective, renewable, and accessible source of energy generation.

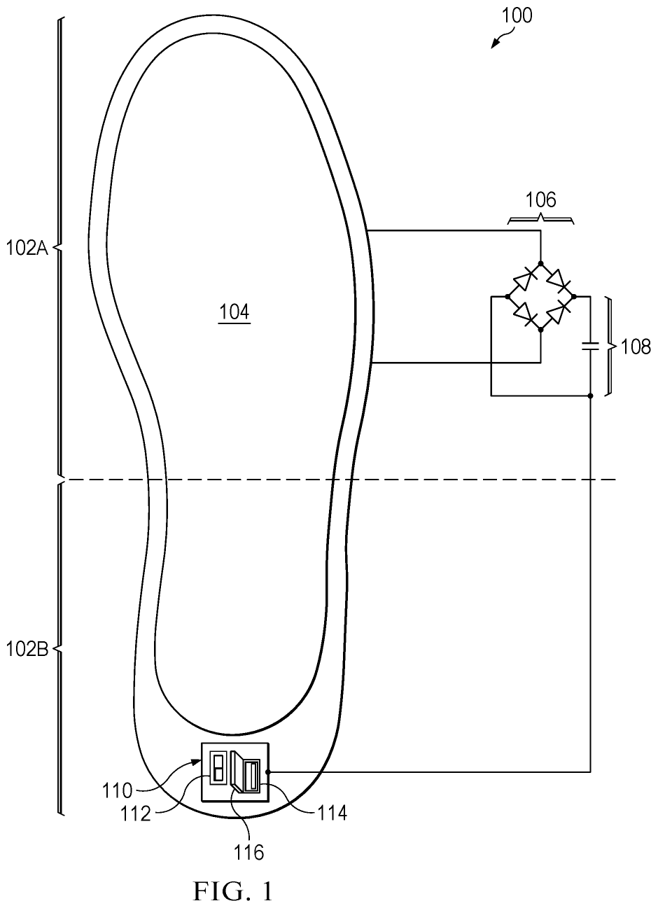

FIG. 1 illustrates an exemplary embodiment of an insert 100 configured to harvest energy exerted from bodily movement. Insert 100 includes a ball portion 102a, a heel portion 102b, and at least one electromechanical transducer 104. As is depicted in FIG. 1, insert 100 may also include a bridge circuit 106, a capacitor 108, a power bank 110, a switch 112, a port 114, and a seal 116. Although this disclosure depicts and describes insert 100 as an insole, insert 100 may also be adapted to be fitted and sealed within a sole of a shoe. Generally, insert 100 harvests energy by converting mechanical energy (e.g., caused by the stress of a foot on insert 100) into electric current that is stored in a power bank until discharged for later use and/or storage by electronic devices.

As noted above, insert 100 includes ball portion 102a and heel portion 102b, wherein ball portion 102a is positioned proximal to one end of insert 100 and heel portion 102b is positioned proximal to an opposite end of insert 100. As will be understood by one of ordinary skill in the art, “heel portion” 102b refers to and includes the portion of insert 100 configured to generally align with a heel of a foot, and “ball portion” 102a refers to and includes the portion of insert 100 configured to generally align with the ball of a foot. As will also be understood by a person of ordinary skill in the art, heel portion 102b of insert 100 may be located on an opposite end of insert 100 from ball portion 102a.

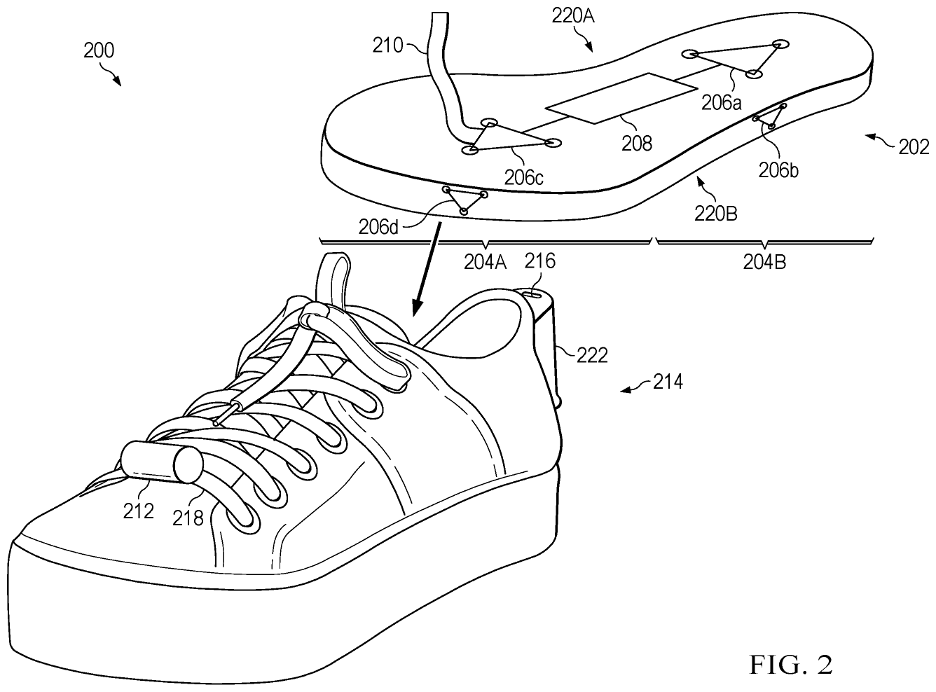

Insert 100 includes at least one electromechanical transducer 104 disposed along insert 100 extending from heel portion 102b. In some embodiments, such as that depicted in FIG. 1, insert 100 includes a single electromechanical transducer 104; in other embodiments, such as that depicted in FIG. 2, insert 202 includes a plurality of electromechanical transducers (see transducers 206a, 206b, 206c, 206d). Insert 100 includes two surfaces (e.g., top and bottom) to which electromechanical transducers 104 can be disposed. Regardless of quantity and/or position, each electromechanical transducer 104 is configured to convert a mechanical signal into an electrical signal. In some embodiments, the mechanical signal may be generated by the stress of a foot upon insert 100, such as from walking, running, jumping, riding a bike, driving a car, and any other type of physical activity where shoes are advised or required. Although this disclosure specifically describes the mechanical signal being generated by the stress of a foot, this disclosure contemplates any suitable mechanical input from bodily movement. This disclosure also recognizes that electromechanical transducers (e.g., transducer 104) may produce alternating current or direct current as output.

At least one electromechanical transducer 104 may include or be various types of transducers. In some embodiments, at least one electromechanical transducer 104 includes at least one piezoelectric sensor. In other embodiments, at least one electromechanical transducer 104 includes at least one pressure sensor. Further embodiments include at least one load cell. Still other embodiments may include a variety of transducers, including one or more piezoelectric sensors, pressure sensors, and load cells.

As described above, insert 100 may include one or more electromechanical transducers 104. One or more electromechanical transducer 104 may be of any suitable size and shape, although transducer 104 may preferably have a size and shape that corresponds with a size and/or shape of insert 100 (e.g., transducer 104 may be congruent or proportional to insert 100). In some embodiments, at least one transducer 104 is the shape and size of heel portion 102b and/or ball portion 102a. Alternatively, at least one transducer 104 may have a shape that is a subset of heel portion 102b and/or ball portion 102a. In other embodiments, such as that depicted in FIG. 1, at least one transducer 104 is disposed along the entire insert 100 and traces the shape of insert 100. In still other embodiments, at least one transducer 104 has a shape corresponding to a typical distribution of foot pressure (e.g., incorporates at least a portion of heel portion 102b, at least a portion of ball portion 102a, and an area extending between such portions along the lateral (outer) side of insert 100).

In some embodiments, at least one electromechanical transducer 104 includes a plurality of transducers disposed along insert 100. As an example, insert 100 may include three (3) piezoelectric sensors disposed in heel portion 102b of insert 100. In other embodiments of insert 100, heel portion 102b may include only one (1) or two (2) piezoelectric sensors positioned therein. In addition to being disposed in heel portion 102b, one or more transducers 104 may be disposed in ball portion 102a. In certain embodiments, such as that depicted in FIG. 2, at least one electromechanical transducer 206a, 206c is disposed along the first surface 220A of the insert and at least one electromechanical transducer 206b, 206d disposed along the second surface 220B of the insert, which is opposite the first surface 220A. As illustrated in FIG. 2, piezoelectric sensors 206c, 206d are positioned in ball portion 204A and piezoelectric sensors 206a, 206b are positioned in heel portion 204B. In yet other embodiments, a plurality of electromechanical transducers 104 are distributed across insert 100 according to a typical distribution of foot pressure. For example, one or more electromechanical transducers 104 may be positioned within heel portion 102b, one or more electromechanical transducers 104 may be positioned within ball portion 102a, and one or more electromechanical transducers 104 may be positioned therebetween along the lateral (outer) side of insert 100.

For the avoidance of doubt, this disclosure recognizes that at least one electromechanical transducer 104 may be formed of a shape other than specifically contemplated herein.

As illustrated in FIG. 1, insert 100 also includes bridge circuit 106. Bridge circuit 106 is electrically coupled to at least one electromechanical transducer 104. In some cases, bridge circuit 106 is electrically coupled to a single electromechanical transducer 104. In other cases, bridge circuit 106 is electrically coupled to a plurality of electromechanical transducers 104. As one of ordinary skill in the art will recognize, converting alternating current to direct current is beneficial given that most electronics require a direct current power supply. This disclosure recognizes that some transducers 104 of insert 100 may produce alternating current as output (rather than direct current). In such embodiments, as illustrated in FIG. 1, bridge circuit 106 is configured to convert the electrical signal generated by at least one electromechanical transducer 104 from alternating current to direct current. For embodiments where transducers 104 of insert 100 produce direct current as output, it may be unnecessary to include the bridge circuit 106 in insert 100.

Bridge circuit 106 may be of various types. In some embodiments, as depicted in FIG. 1, bridge circuit 106 is a diode rectifier bridge. In other embodiments, bridge circuit 106 is a full bridge rectifier, full-wave diode bridge rectifier, a controlled rectifier, or a half-wave rectifier. Although this disclosure specifically recognizes certain types of bridge circuits, this disclosure contemplates using insert 100 comprising any suitable bridge circuit 106 capable of converting alternating current to direct current.

For embodiments of insert 100 that include bridge circuit 106, such circuit may be further configured to discharge direct current converted from alternating current into power bank 110. In some embodiments, bridge circuit 106 is indirectly coupled to power bank 110 (e.g., via an electrical cable). In other embodiments, bridge circuit 106 is directly coupled to the power bank and can directly discharge direct current converted from alternating current into power bank 110. As will be described in more detail below, bridge circuit 106 may, in some embodiments, be configured to discharge direct current to capacitor 108 before such current is further directed to power bank 110. In any event, bridge circuit 106 may be configured to discharge the current into power bank 110 when bridge circuit 106 is electrically coupled (e.g., directly or indirectly) to power bank 110. In other additional embodiments, bridge circuit 106 is directly coupled to the electronic device and can directly discharge stored direct current into the electronic device (e.g., cellphones, lights, and appliances).

Other embodiments of insert 100 may also include one or more additional components, such as capacitor 108, power bank 110, switch 112, power bank port 114, and power bank port seal 116. For example, as illustrated in FIG. 1, insert 100 may include bridge circuit 106 that is configured to discharge direct current to capacitor 108 before such current is directed to power bank 110. Capacitor 108 may be configured to receive direct current discharged by bridge circuit 106 and store the direct current prior to discharging the direct current into power bank 110. As another example, as also shown in FIG. 1, insert 100 may further include switch 112 that is electrically coupled to bridge circuit 106 and/or capacitor 108, and switch 112 may be configured to permit or restrict the flow of direct current to other components (e.g., power bank 110). In embodiments with switch 112, switch 112 connects the conducting path in the circuit, allowing direct current to flow into power bank 110. Switch 112 may also be configured to disconnect the conducting path of the electrical components to prevent discharging direct current into power bank 110, when desired.

In some embodiments, insert 100 includes an integral power bank 110 to which direct current is discharged. As depicted in FIG. 1, power bank 110 may be positioned in heel portion 102b of insert 100 such that power bank 110 does not interfere with the comfort of insert 100. In other embodiments, power bank 110 may be located between the first and second surfaces of insert 100. In additional embodiments, power bank may be integrated with foot-support features of insert 100. For example, in one embodiment, the insert 100 may be an orthotic insert, where the power bank 110 is integrated into the insert and is shaped such that it provides the structure and shape of the orthotic insert. Other embodiments may include an integral power bank 110 along or disposed within second surface (e.g., bottom) 220B of insert 100.

This disclosure also contemplates an embodiment where the power bank is not integrated into the insert. This disclosure further details such embodiments with respect to FIG. 2. As depicted in FIG. 2, power bank 212 may be coupled to, or integrated with, a shoe such that insert 100 described herein forms a system with one or more of a shoe and/or power bank 110.

This disclosure also contemplates an embodiment that includes more than one power bank. In such an embodiment, the two or more power banks may be disposed within insert 100 and/or be coupled to or disposed within shoe 214. In a system that includes more than one power bank, the power banks may be connected in series or in parallel.

Power bank 110 may include port 114 for external access and connections. Electrical and/or charging cables are configured to couple to port 114, which are then used to power and/or charge other electronic devices (e.g., cellphones, lights, vehicles and appliances). In some embodiments, port 114 may be configured to accept a standard type of electrical and/or charging cable connector, including but not limited to USB-A, USB-B, USB-C, Mini USB, Micro USB, Lightning connector, and Apple 30-pin connector. In some embodiments, as further shown in FIG. 1, power bank 110 may also include seal 116 for covering port 114 to keep port 114 from being subject to damage from water, dust, debris, or the like. In additional embodiments, power bank 110 may include the capability to wirelessly power and/or charge other electronic devices (e.g., cellphones, lights, vehicles and appliances). In another embodiment, a wireless-charging device may be coupled to port 114 of power bank 110 and the wireless-charging device may be used to power and/or charge other electronic devices (e.g., cellphones, lights, vehicles and appliances).

FIG. 2 illustrates a system 200 for harvesting energy from bodily movement. System 200 may be configured to include an assembly of a shoe 214 and an insert 202.

As illustrated in FIG. 2, one embodiment of system 200 includes shoe 214 and insert 202. As depicted, insert 202 includes a ball portion 204A, a heel portion 204B, two electromechanical transducers in the ball portion (i.e., transducers 206c, 206d), one being disposed along a first surface 220A of the insert, and one being disposed along a second surface 220B of the insert 220B, two electromechanical transducers in the heel portion (i.e., transducers 206a, 206b), one being disposed along a first surface of the insert 220A, and one being disposed along the second surface of the insert 220B, circuitry 208, an electrical cable 210, and a power bank 212. Generally, insert 202 harvests energy by converting mechanical energy (e.g., caused by the stress of a foot on insert 202) to alternating current using electromechanical transducers 206 (e.g., 206a, 206b, 206c, 206d) and further converting alternating current to direct current using circuitry 208 before discharging direct current to power bank 212 via electrical cable 210. This disclosure recognizes that the shoe 214, insert 202, and power bank 212 of this system 200 may be used simultaneously with a second similar system (e.g., for use with another shoe) in order to maximize the amount of energy to be harvested.

As noted above, insert 202 includes ball portion 204A and heel portion 204B, wherein ball portion 204A is positioned on one end of insert 202 and heel portion 204B is positioned on the opposite end of insert 202.

As depicted in FIG. 2, the first surface of the insert 220A contains three (3) electromechanical transducers 206a on the heel portion of insert 202 and three (3) electromechanical transducers 206c on the ball portion of insert 202. A second surface of the insert 220B contains three (3) electromechanical transducers 206b on the heel portion and three (3) electromechanical transducers 206d on the ball portion. Each of the electromechanical transducers 206a, 206b, 206c, 206d may be electrically connected to each other. Electromechanical transducers 206a, 206b, 206c, 206d depicted in FIG. 2 may have the same properties and characteristics as that described with respect to electromechanical transducers 104 in FIG. 1. FIG. 2 depicts electromechanical transducers 206a, 206b, 206c, 206d of a triangular shape, but as stated previously for electromechanical transducers 104 in FIG. 1, this disclosure recognizes that electromechanical transducers 206a, 206b, 206c, 206d may also be of any suitable shape that permits the functionality described herein.

Circuitry 208 is electrically coupled to electromechanical transducers 206a, 206b, 206c, 206d and may include one or more of bridge circuit 106, capacitor 108, and switch 112. Circuitry 208 allows for alternating current generated by electromechanical transducers 206a, 206b, 206c, 206d to be converted into direct current by bridge circuit 106, received and stored by capacitor 108, and released by switch 112 into power bank 212. Although this disclosure depicts circuitry 208 connected to electromechanical transducers 206a, 206b, 206c, 206d this disclosure recognizes that certain electromechanical transducers 206a, 206b, 206c, 206d produce direct current as output (rather than alternating current), and for such embodiments, one or more subcomponents of circuitry 208 may be rendered unnecessary.

As will be recognized by one of ordinary skill in the art, direct current generated via insert 202 may be transferred to power bank 212 via electrical cable 210, which may also form part of any system 200 comprising insert 202. As illustrated in FIG. 2, electrical cable 210 is electrically coupled to circuitry 208. In other embodiments, electrical cable 210 is coupled to bridge circuit 106 or capacitor 108 and configured to direct the flow of direct current discharged from bridge circuit 106 and/or capacitor 108 to power bank 212. To the extent that electromechanical transducers 206a, 206b produce direct current as output and circuitry 208 is rendered unnecessary, electrical cable 210 may also be coupled, directly or indirectly, to electromechanical transducers 206a, 206b, 206c, 206d.

In some embodiments, such as that depicted in FIG. 2, electrical cable 210 may extend from the first surface 220A of the insert proximal to ball portion 204A, thread through at least one aperture of shoe 214, and couple to power bank 212. In some embodiments, the place where the electrical cable 210 is positioned along insert 202 at the approximate location of a toe post of a sandal (e.g., a flip-flop), between the first and second digit of a foot. In some embodiments, the aperture that electrical cable 210 is threaded through may also accommodate, separately or together with, a shoelace.

In other non-depicted embodiments, insert 202 and shoe 214 may have electrical connectors configured to create an electrical connection when insert 202 is inserted into shoe 214. The connector on insert 202 may be electrically coupled to circuitry 208 and/or electromechanical transducers 206a, 206b, 260c, 206d. The connector on shoe 214 may be electrically coupled to electrical cable 210 and/or power bank 212. In some embodiments, electrical cable 210 may be built into the body and/or sole of shoe 214.

Power Bank 212 may function similarly to power bank 110 described above with respect to FIG. 1.

As will be recognized by one of ordinary skill in the art, various comfort benefits may be realized by thoughtfully positioning electrical cable 218 and/or port 216 within shoe 214. In some embodiments, electrical cable 218 may be coupled to shoe 214 via port 216, which may be located on an exterior portion of shoe 214 in some embodiments. For example, as discussed above, cable 218 may be positioned at the approximate location of a toe post and extend through an aperture of shoe 214. For example, as discussed above, cable 218 may be positioned at the approximate location of a toe post and extend through an aperture of shoe 214. As another example, as discussed with respect to FIG. 1 and as further depicted in FIG. 2, port 216 may be located proximal to heel portion 204B of insert 202. As shown in FIG. 2, port 216 is configured to project out from the back of a shoe and retract back into the back of the shoe.

In some embodiments, such as that depicted in FIG. 2, port 216 is positioned within a protractable portion 222 of shoe 214, which may be positioned along the backstay, counter or heel counter of shoe 214 and is configured to move from a closed, unusable position to an open, usable position. In the open position, protractable portion 222 is not flush with the body of shoe 214 and port 216 is exposed. When the protractable portion 222 is in the open position, electrical and/or charging cables may be removably coupled to port 216, which are then used to power and/or charge other electronic devices (e.g., cellphones, lights, vehicles and appliances). In the closed position, protractable portion 222 is flush with the body of shoe 214 and port 216 is hidden. In some embodiments, protractable portion 222 may be hinged such that manipulation of the protractable portion 222 opposite the hinge will configure it into the open position and manipulating the side of the protractable portion opposite the hinge will configure it into the closed position. In some additional embodiments, protractable portion 222 may be configured such that when protractable portion 222 is in the closed position, port 216 is sealed to keep port 216 from being subject to damage from dust, water, debris, or the like.

Protractable portion 222 may be placed on any suitable portion of shoe 214. In some embodiments, protractable portion 222 may be placed on or around the backstay, counter, or heel counter of shoe 214. Electrical cable 218 may electrically couple to port 216 within protractable portion 222.

Although FIG. 2 illustrates power bank 212 as coupled to the shoelaces of shoe 214, this disclosure recognizes that power bank 212 may be coupled to any exterior part of shoe 214. Power bank 212 may then use direct current to power and/or charge various electronic devices (e.g., cellphones, lights, and appliances). Power bank 212 may be configured such that it is removably coupled (e.g., detachable) from shoe 214. The detachability of power bank 212 provides various benefits, including allowing an individual to go through an airport security checkpoint without removing his/her shoes, and instead only requiring the power bank 212 to be removed.

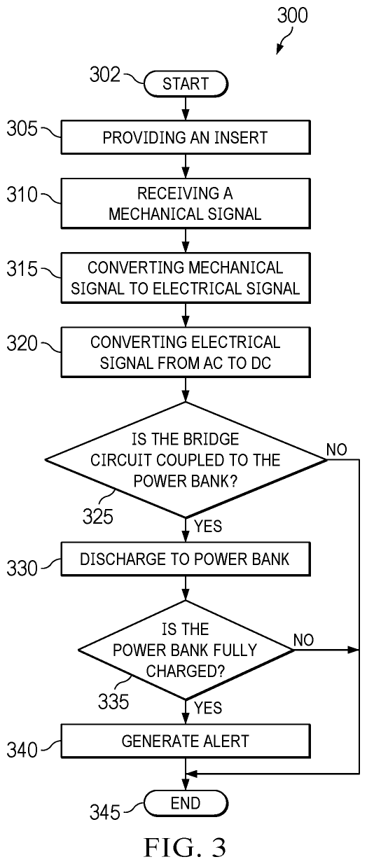

Turning now to FIG. 3, a method 300 of harvesting energy using insert 100 and/or 202 is illustrated. Method 300 generally describes using a shoe insert to harvest energy by converting mechanical energy from bodily movement to electrical current to power various electronic devices (e.g., cellphones, computers, lights, and appliances).

Method 300 may begin at step 302 and may continue to step 305. At step 305, insert 100, such as the one depicted in FIG. 1, and/or insert 202, such as the one depicted in FIG. 2, is provided to convert energy from bodily movement to electrical current. In some embodiments, as illustrated in FIG. 1 and FIG. 2, insert 100 and/or 202 may be an insole. In other embodiments, insert 100 and/or 202 may be adapted to be fitted and sealed within shoe 214.

At step 310, insert 100 and/or 202, receives a mechanical signal from bodily movement, such as walking, running, jumping, riding a bike, driving a car, or any other type of physical activity where shoes are advised or required. Although this disclosure specifically describes the mechanical signal being generated from the stress of a foot, this disclosure contemplates any suitable mechanical input from bodily movement.

At step 315, insert 100 and/or 202 will convert the received mechanical signal into an electrical signal via at least one electromechanical transducer (e.g., transducers 104, 206a, 206b, 206c, 206d).

At step 320, insert 100 and/or 202 will convert the electrical signal from alternating current to direct current using bridge circuit 106 or circuitry 208.

At step 325, it is determined whether bridge circuit 106 and/or circuitry 208 is coupled to power bank 110. If, at step 325, it is determined that bridge circuit 106 and/or circuitry 208 is coupled to a power bank (e.g., power bank 110 or 212), method 300 may proceed to step 330. If, however, it is determined at step 325 that bridge circuit 106 and/or circuitry 208 is not coupled to a power bank (e.g., power bank 110 or 212), method 300 proceeds to an end step 345.

If, at step 325, it is determined that bridge circuit 106 and/or circuitry 208 is directly or indirectly coupled to a power bank (e.g., power bank 110 or 212), method may proceed to step 330. At step 330, direct current will be discharged to a power bank (e.g., power bank 110 or 212) via bridge circuit 106 or circuitry 208. Bridge circuit 106 may couple to one or more of capacitor 108, switch 112, and port 114. Circuitry 208 may include one or more of bridge circuit 106 or capacitor 108. And circuitry 208 may couple to one or more of switch 112, and port 216. Once direct current is discharged to a power bank (e.g., power bank 110 or 212), method 300 proceeds to step 335.

At step 335, it is determined whether the power bank (e.g., power bank 110 or 212) is fully charged. If, at step 335, the power bank (e.g., power bank 110 or 212) is fully charged, method 300 may proceed to step 340. If, however, it is determined at step 335 that the power bank (e.g., power bank 110 or 212) is not fully charged, method 300 proceeds to an end step 345.

If, at step 335, it is determined that the power bank (e.g., power bank 110 or 212) is fully charged, method 300 proceeds to step 340. At step 340, an alert is generated to notify that the power bank (e.g., power bank 110 or 212) is fully charged. In some embodiments, there may be an accompanying communicative interface that generates this alert for the user. In other embodiments, the alert may be a visual or audio signal. The alert may be communicated via any suitable means, including wired or wireless transmission channels (e.g., Bluetooth).

If, however, it is determined at step 335 that the power bank (e.g., power bank 110 or 212) is not fully charged, method 300 proceeds to an end step 345. In such embodiments, the power bank (e.g., power bank 110 or 212) may continue to receive the direct current discharged by bridge circuit 106 and/or circuitry 208 until the power bank (e.g., power bank 110 or 212) is fully charged.

If, however, it is determined at step 325 that bridge circuit 106 and/or circuitry 208 is not coupled to the power bank (e.g., power bank 110 or 212), method 300 proceeds to an end step 345. In such embodiments, direct current converted may remain stored within capacitor 108, 208, until bridge circuit 106 and/or circuitry 208 is directly or indirectly coupled to the power bank (e.g., power bank 110 or 212).

Various embodiments may perform some, all, or none of the steps described above. For example, in certain embodiments, at least one electromechanical transducer (e.g., transducers 104, 206a, 206b, 206c, 206d) may not need to convert the electrical signal from alternating current to direct current at step 320 if one or more electromechanical transducers produce direct current as output rather than alternating current. Furthermore, in certain embodiments, one or more steps of method 300 may be repeated.

The present disclosure contemplates use of the described inserts in third-world countries to power everyday devices (e.g., lights, water filtration systems), but also has applications for use by hikers, first responders, and everyday people with a need to power their devices. This disclosure also contemplates additional functionalities of the described inserts, such as being communicably coupled to other devices which may allow, for example, for notifications (e.g., alerting a user when the power bank is fully charged) or GPS tracking. The described inserts may be communicably coupled to other devices using, for example, a network or a Bluetooth connection. Other contemplated use cases for the described inserts include implementing community power banks where users could deposit the direct current generated by said inserts. The collective energy generated from a large number of users could potentially power entire communities, businesses, homes, schools, and more.

As discussed in various sections of this disclosure, the described inserts may also be adapted to fit within the sole of shoe 214. For example, this disclosure contemplates specialized shoes that are adapted to accommodate the insert. For example, a specialized shoe contemplated by the disclosure includes a zipper along the sole. When unzipped, the sole will fully or partially detach from the specialized shoe allowing insertion of an embodiment of the invention.

Embodiments of the invention comprising a specialized shoe that has a zipper for attaching the sole to the shoe have various benefits. These benefits include additional protection for the internal circuitry of insert from damage due to wear from use. These benefits also include the ability to quickly and easily replace insert if it malfunctions. These benefits further include the ability to quickly and easily replace insert, which may have an integrated power bank, when power bank has been fully charged. Replacing insert when power bank has been charged increases the amount of power capture that may occur during walking or may allow power bank to be used to power electronic devices (e.g., cellphones, computers, lights, furnaces, appliances, and vehicles) while another power bank 110 is simultaneously being charged.

Modifications, additions, or omissions may be made to insert 100 without departing from the scope of the disclosure. Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

The invention claimed is:

1. A system comprising:
a shoe;
an insert adapted to fit in the shoe comprising:
a ball portion positioned proximal to a first end of the insert;
a heel portion positioned distal to the first end of the insert;
at least one electromechanical transducer configured to convert the mechanical signal into an electrical signal, wherein:
the at least one electromechanical transducer is disposed along the insert extending from the heel portion;
the at least one electromechanical transducer comprises a first electromechanical transducer and a second electromechanical transducer, wherein:
the first electromechanical transducer is a piezoelectric sensor disposed along a first surface of the insert; and
the second electromechanical transducer is a piezoelectric sensor disposed along a second surface of the insert, the second surface being opposite the first surface;
a bridge circuit electrically coupled to the at least one electromechanical transducer, wherein:
the bridge circuit is a diode rectifier bridge;
the bridge circuit is configured to:
convert the electrical signal generated by the at least one electromechanical transducer from alternating current to direct current; and
discharge the direct current;
a capacitor electrically coupled to the bridge circuit and configured to:
receive the direct current discharged by the bridge circuit; and
store the direct current;
a cable electrically coupled to the capacitor and configured to direct the flow of direct current discharged from the capacitor, wherein:
the cable is configured to protrude through the first surface of the insert proximal to the first end of the insert and thread through at least one aperture of the shoe;
a switch electrically coupled to the capacitor and configured to permit or restrict a flow of the direct current from the capacitor; and
a power bank adapted to couple to the shoe or a shoelace, the power bank being configured to:
electrically couple to the insert via the cable;
receive the direct current discharged from the insert when the switch permits the flow of the direct current; and
store the direct current.

2. An insert adapted to fit in a shoe, the insert comprising:
a ball portion positioned proximal to a first end of the insert;
a heel portion positioned proximal to a second end of the insert opposite the first end;
at least two electromechanical transducers configured to convert a mechanical signal into an electrical signal, wherein:
one of the at least two electromechanical transducers is disposed along a first surface of the insert extending from the heel portion; and
another of the at least two electromechanical transducers is disposed along a second surface of the insert, the second surface being opposite the first surface;
a bridge circuit electrically coupled to the at least one electromechanical transducer and is configured to:
convert the electrical signal generated by one or more of the at least two electromechanical transducers from alternating current to direct current; and
discharge the direct current into a power bank when the bridge circuit is electrically coupled to the power bank.

3. The insert of claim 2, wherein the at least two electromechanical transducers comprises at least one of:
a piezoelectric sensor;
a pressure sensor; or
a load cell.

4. The insert of claim 2, wherein the at least two electromechanical transducers comprises a third electromechanical transducer disposed along either the first surface or the second surface of the insert.

5. The insert of claim 2, wherein one of the at least two electromechanical transducers corresponds to a shape or size of the insert.

6. The insert of claim 2, wherein the at least two electromechanical transducers are shaped or arranged comprise a lateral side portion of the insert between the ball portion and the heel portion.

7. The insert of claim 2, wherein the bridge circuit is a diode rectifier bridge.

8. The insert of claim 2, further comprising a capacitor electrically coupled to the bridge circuit and configured to receive the direct current discharged by the bridge circuit and store the direct current.

9. The insert of claim 8, further comprising a switch electrically coupled to the capacitor and configured to electrically couple to the power bank, wherein the switch is configured to permit or restrict a flow of the direct current from the capacitor.

10. The insert of claim 2, further comprising a cable electrically coupled to the bridge circuit and configured to direct the flow of direct current into the power bank.

11. The insert of claim 10, wherein the cable is further configured to protrude through the first surface of the insert proximal to the first end of the insert.

12. The insert of claim 2, wherein the power bank is disposed within the heel portion of the insert and comprises at least one port configured to be sealed with a port cover.

13. A method comprising:
providing an insert adapted to fit in a shoe, the insert comprising a ball portion, a heel portion, at least two electromechanical transducers, and a bridge circuit, wherein:
the ball portion is positioned proximal to a first end of the insert;
the heel portion is positioned proximal to a second end of the insert opposite the first end;
one of the at least two electromechanical transducers is disposed along a first surface of the insert extending from the heel portion; and
another of the at least two electromechanical transducers is disposed along a second surface of the insert, the second surface being opposite the first surface;
receiving, by one or more of the at least two electromechanical transducers, a mechanical signal;
converting, by the one or more of the at least two electromechanical transducers, the mechanical signal into an electrical signal;
converting, by the bridge circuit, the electrical signal from an alternating current to direct current; and
discharging, by the bridge circuit, the direct current into a power bank when the bridge circuit is electrically coupled to the power bank.

14. The method of claim 13, further comprising directing the direct current from the bridge circuit to a capacitor electrically coupled to the bridge circuit.

15. The method of claim 14, further comprising storing the direct current from the bridge circuit in the capacitor.

16. The method of claim 14, further comprising directing the direct current stored in the capacitor to the power bank in response to activating a switch.

17. The method of claim 13, wherein the direct current is discharged into the power bank via a cable.

18. The method of claim 13, further comprising storing electrical energy in a battery of the power bank.

19. The method of claim 18, further comprising transmitting, via a communication interface, an indication of an amount of electrical energy stored in the battery of the power bank.

20. The method of claim 18, further comprising directing the flow of electrical energy from the battery of the power bank to an output port of the power bank.
